(19) United States
(12) Patent Application Publication
(10) Pub. No.: US 2026/0079241 A1
(43) Pub. Date: Mar. 19, 2026

(54) SOLID STATE LIGHT DETECTION AND RANGING TRAFFIC SENSOR SYSTEM

(71) Applicant: Yaacov FRUCHT, Kibutz Ein Hamifratz (IL)

(72) Inventor: Yaacov FRUCHT, Kibutz Ein Hamifratz (IL)

(21) Appl. No.: 19/329,439

(22) Filed: Sep. 15, 2025

Related U.S. Application Data
(60) Provisional application No. 63/695,333, filed on Sep. 16, 2024.

(51) Int. Cl. G01S 7/48; G01S 7/484; G01S 7/4861; G01S 7/4865; G01S 7/487; G01S 17/58; G01S 17/88; G08G 1/017

(52) U.S. Cl. CPC G01S 7/4802; G01S 7/484; G01S 7/4861; G01S 7/4865; G01S 7/4873; G01S 17/58; G01S 17/88; G08G 1/017

(57) ABSTRACT

The present disclosure provides a solid-state LIDAR traffic sensor system comprising a housing configured for installation over a traffic lane, two laser range finders positioned within the housing where each laser range finder comprises a solid-state laser transmitter and a solid-state receiver with no moving parts, wherein the two laser range finders are spaced apart by a predetermined distance and oriented to create two parallel laser detection zones across a width of the traffic lane, and a timing and processing unit operatively connected to both laser range finders and configured to measure time intervals between vehicle detection events at each laser detection zone, calculate vehicle velocity based on the predetermined distance between the laser range finders and the measured time intervals, count vehicles crossing both laser detection zones, generate vehicle height profiles by measuring momentary height of vehicle cross-sections as vehicles pass under each laser range finder, determine vehicle length based on calculated vehicle velocity and time duration of vehicle presence at the laser detection zones, and classify vehicles based on the generated vehicle height profiles and determined vehicle length.

### CROSS-REFERENCE TO RELATED APPLICATIONS

This application claims priority to U.S. Provisional Patent Application No. 63/695,333 filed Sep. 16, 2024, which is hereby incorporated by reference in its entirety.

### FIELD OF INVENTION

The present disclosure relates to traffic monitoring and control systems, and more particularly to a solid-state Light Detection and Ranging (LIDAR) based sensor system for counting, measuring velocity, and classifying vehicles using dual laser range finders without moving parts.

### BACKGROUND

Traffic monitoring and control systems play a fundamental role in modern transportation infrastructure, providing data for traffic management, law enforcement, and highway planning. These systems typically perform three primary functions: counting vehicles, measuring vehicle velocities, and classifying vehicles by type or size. Accurate and reliable traffic data collection enables transportation authorities to optimize traffic flow, enhance safety measures, and make informed decisions about infrastructure improvements.

Various sensor technologies have been developed for traffic monitoring applications. Radar-based systems utilize electromagnetic waves to detect and track vehicles, while camera-based systems employ image processing techniques to analyze traffic patterns. Another approach involves laser beam systems that position a laser transmitter on one side of a roadway and a corresponding sensor on the opposite side, creating a detection zone across the traffic lane.

LIDAR technology has emerged as a prominent solution for traffic monitoring due to its ability to provide precise distance measurements and detailed spatial information. LIDAR systems employ laser scanners that mechanically sweep laser beams across detection areas to gather comprehensive data about passing vehicles. These scanning systems can perform traffic monitoring functions, making them attractive for comprehensive traffic analysis applications.

However, conventional LIDAR-based traffic sensors face certain limitations related to their mechanical scanning components. Moving parts in laser scanning systems can introduce maintenance requirements and potential reliability concerns over extended operational periods. Additionally, the size and weight of traditional scanning LIDAR systems may present installation challenges, particularly for overhead mounting configurations commonly used in highway traffic monitoring.

The accuracy of velocity measurements in traffic monitoring systems can be affected by various factors, including environmental conditions, sensor positioning tolerances, and the measurement methodology employed. Achieving high measurement accuracy while maintaining system reliability and minimizing false detections from environmental noise, such as solar reflections, remains an ongoing challenge in traffic sensor design.

There exists a general need for traffic monitoring systems that can provide accurate multi-function capabilities while addressing the limitations associated with mechanical scanning components and environmental interference. Solid-state approaches that eliminate moving parts while maintaining measurement precision could offer advantages in terms of system reliability, maintenance requirements, and installation flexibility.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a solid-state LIDAR traffic sensor system is provided. The system includes a housing configured for installation over a traffic lane. Two laser range finders are positioned within the housing, where each laser range finder includes a solid-state laser transmitter and a solid-state receiver with no moving parts. The two laser range finders are spaced apart by a predetermined distance and oriented to create two parallel laser detection zones across the width of the traffic lane. A timing and processing unit is operatively connected to both laser range finders and configured to measure time intervals between vehicle detection events at each laser detection zone. The timing and processing unit calculates vehicle velocity based on the predetermined distance between the laser range finders and the measured time intervals. The timing and processing unit counts vehicles crossing both laser detection zones. The timing and processing unit generates vehicle height profiles by measuring momentary height of vehicle cross-sections as vehicles pass under each laser range finder. The timing and processing unit determines vehicle length based on calculated vehicle velocity and time duration of vehicle presence at the laser detection zones. The timing and processing unit classifies vehicles based on the generated vehicle height profiles and determined vehicle length.

According to other aspects of the present disclosure, the system may include one or more of the following features. Each laser range finder may include a laser diode transmitter that generates a wide-angle flat laser beam covering the width of a traffic lane. Each laser range finder may include an avalanche photodiode detector or PIN photodiode detector as the receiver. The timing and processing unit may operate at a pulse repetition frequency of 2-10 kHz. The timing and processing unit may include noise correction circuitry configured to adjust detection thresholds based on environmental noise levels including solar reflections. The predetermined distance between the laser range finders may be accurately measured during system assembly. The system may achieve velocity measurement accuracy of 1.5% for vehicles traveling at speeds up to 250 km/h. The housing may have dimensions of approximately 25 cm and weigh approximately 1.3 kg. Each laser range finder may include a time-to-voltage converter for measuring laser pulse time of flight. The system may include automatic threshold adjustment based on detected noise levels to minimize false pulse detection while maintaining high detection probability for reflected laser pulses from vehicles.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a block diagram of a laser range finder system, according to aspects of the present disclosure.

FIG. 2 depicts a transmitter scheme block diagram for the laser range finder system of FIG. 1, according to aspects of the present disclosure.

FIG. 3 illustrates a receiver scheme for the laser range finder system of FIG. 1, according to aspects of the present disclosure.

FIG. 4 depicts an ATLAS system configuration with dual laser range finders in a housing, according to aspects of the present disclosure.

FIG. 5 illustrates an angular coverage diagram and velocity error characteristics for the ATLAS system of FIG. 4, according to aspects of the present disclosure.

FIG. 6 depicts a graph showing error per vehicle velocity for the ATLAS system, according to aspects of the present disclosure.

FIG. 7 illustrates velocity error due to beam tilt tolerance in the ATLAS system, according to aspects of the present disclosure.

FIG. 8 depicts velocity error due to beam yaw tolerance in the ATLAS system, according to aspects of the present disclosure.

FIG. 9 illustrates velocity error due to sensor yaw tolerance in the ATLAS system, according to aspects of the present disclosure.

FIG. 10 depicts velocity error due to sensor roll tolerance in the ATLAS system, according to aspects of the present disclosure.

FIG. 11 illustrates a sampling error data table for the ATLAS system, according to aspects of the present disclosure.

FIG. 12 illustrates an example of a method.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The specification refers to one or more laser detection zones. A laser detection zone may be a continuous laser detection curtain and/or may be a non-continuous laser coverage such as a set of laser beams that may be spaced apart from each other and be of different orientations (for example—laser beams of different radial angles)—or form any other beam pattern—such as a beam pattern in which one or more beams may cross each other and/or having one or more laser beams parallel to each other, and the like.

Traffic monitoring and control systems have become increasingly important for managing vehicle flow on modern roadways. Traditional approaches for traffic sensing may utilize various technologies including radar-based systems, camera-based systems, and laser beam systems that employ a laser transmitter on one side of a roadway and a corresponding sensor on the opposite side. These conventional systems may perform one or more functions such as vehicle counting, velocity measurement, and vehicle classification, though many systems may be limited in their ability to perform all three functions simultaneously with high accuracy.

LIDAR-based sensors have emerged as a viable approach for traffic control applications due to their ability to provide precise distance measurements and detailed object detection capabilities. Some existing LIDAR systems for traffic monitoring may employ mechanical scanning mechanisms with rotating components to sweep laser beams across detection areas. These scanning systems may utilize multiple laser scanners per lane to achieve the desired functionality of counting, measuring velocity, and classifying vehicles passing through monitored areas.

Solid-state LIDAR systems offer potential advantages over mechanical scanning approaches by eliminating moving parts that may be subject to wear and mechanical failure over time. Such solid-state systems may provide enhanced reliability and reduced maintenance requirements while maintaining the measurement capabilities needed for comprehensive traffic monitoring. The development of compact, lightweight solid-state LIDAR sensors may enable more flexible installation options and broader deployment across various traffic infrastructure configurations.

Advanced traffic monitoring systems may benefit from the integration of multiple laser range finding components configured to create laser detection zones across vehicle travel lanes. Such systems may employ sophisticated algorithms to process range measurements and extract vehicle characteristics including speed, dimensions, and classification parameters. The combination of multiple range finding units with appropriate spacing and timing analysis may enable accurate determination of vehicle velocities through time-of-flight calculations between detection points.

Modern traffic sensor systems may also incorporate adaptive signal processing techniques to address environmental challenges such as varying lighting conditions, weather effects, and background noise. These systems may employ automatic threshold adjustment mechanisms and noise compensation algorithms to maintain consistent detection performance across diverse operating conditions. The integration of high-frequency pulse repetition rates with precise timing circuits may enable rapid measurement cycles suitable for monitoring high-speed traffic scenarios.

The ATLAS system may include a compact, solid-state traffic monitoring device designed for deployment in various roadway infrastructure configurations. The system may incorporate dual laser range finder units housed within a single enclosure to provide comprehensive vehicle detection and analysis capabilities. In some cases, the housing may contain both laser range finder components along with associated processing electronics and interface connections in an integrated package suitable for field installation.

The physical dimensions of the ATLAS system may be configured to facilitate installation in space-constrained environments typical of traffic monitoring applications. The overall size of the system may be approximately 25 centimeters, providing a compact form factor that may enable flexible mounting options across different infrastructure configurations. This compact design may allow for installation in locations where larger conventional traffic sensors might not be practical due to space limitations or structural constraints.

Weight considerations may play a role in the deployment and mounting requirements for traffic monitoring systems. The ATLAS system may have a weight of approximately 1.3 kilograms, which may reduce structural loading requirements on mounting hardware and support structures. The lightweight design may facilitate easier installation procedures and may reduce the need for heavy-duty mounting brackets or reinforced support structures that might otherwise be required for heavier sensor systems.

Installation configurations for the ATLAS system may include mounting on bridge structures positioned over highway lanes for traffic monitoring applications. Bridge-mounted installations may provide advantageous positioning for traffic sensors by offering elevated vantage points that may enable clear line-of-sight detection of vehicles passing below. Such installations may be integrated with existing traffic control sensor networks to provide comprehensive monitoring coverage across multiple lanes or roadway sections.

The dual laser range finder configuration within the ATLAS system may create spatially separated laser detection zones that enable velocity measurements through time-of-flight analysis between detection points. The arrangement of the two laser range finder units may be precisely controlled during system assembly to establish known spacing distances that may serve as reference measurements for velocity calculations. The housing design may maintain the relative positioning of the laser range finder components while providing environmental protection for the optical and electronic components during field operation.

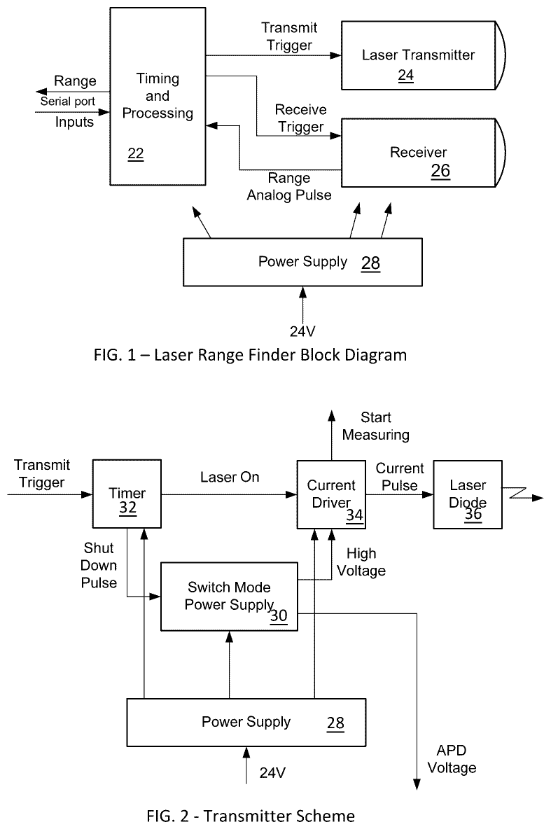

Referring to FIG. 1, the laser range finder system may include several fundamental components that work together to provide distance measurement capabilities for traffic monitoring applications. The system architecture may include a timing and processing unit 22 that serves as the central control element for coordinating measurement operations and data processing functions. The timing and processing unit may receive range measurements and serial port communications while managing the operational timing sequences for both transmission and reception of laser pulses. A power supply 28 providing supply voltage (for example 24V) may connect to the timing and processing unit along with other system components to provide the electrical energy needed for system operation.

The laser transmitter 24 may receive control signals from the timing and processing unit to generate optical pulses for range measurement operations. The timing and processing unit 22 may send transmit trigger signals to the laser transmitter to initiate the emission of laser pulses at predetermined intervals. The laser transmitter may be configured to produce optical energy that propagates toward target objects within the detection range of the system. The coordination between the timing and processing unit and the laser transmitter may enable precise control over pulse timing and repetition rates that may be suitable for traffic monitoring applications.

The receiver 26 may detect reflected laser energy returning from target objects and convert the optical signals into electrical signals for processing. As shown in FIG. 1, the receiver may provide receive trigger signals and range analog pulses back to the timing and processing unit for analysis and measurement calculations. The receiver may incorporate photodetector elements that may respond to the wavelength of the transmitted laser energy and convert the received optical signals into corresponding electrical currents or voltages. The range analog pulse output from the receiver may contain amplitude information that corresponds to the time-of-flight measurements between pulse transmission and reception.

With continued reference to FIG. 1, the interconnection between the timing and processing unit, laser transmitter, and receiver may enable bidirectional communication and control signal flow throughout the system. The timing and processing unit may coordinate the transmission timing with the reception processing to calculate accurate range measurements based on the time delay between transmitted and received pulses. The system may be configured for operation at altitude ranges of 6-20 meters, which may be suitable for bridge-mounted installations over highway traffic lanes. The power distribution from the 24V supply may provide appropriate voltage levels for the electronic circuits within each component while maintaining stable operation across varying environmental conditions.

As further shown in FIG. 2, the transmitter scheme may include a timer 32 that receives transmit trigger inputs from the timing and processing unit and generates control signals for laser pulse generation. The timer may produce a laser on signal and a shutdown pulse that coordinate the operation of downstream components within the transmitter assembly. A switch mode power supply 30 may receive the shutdown pulse from the timer and provide high voltage output to a current driver 34. The current driver may receive the high voltage from the switch mode power supply and convert the electrical energy into current pulses suitable for driving a laser diode 36.

The laser diode within the transmitter scheme may receive current pulses from the current driver and convert the electrical energy into optical pulses for transmission toward target objects. The laser diode may also connect to an APD voltage output that may provide feedback or monitoring signals related to the optical output characteristics. The switch mode power supply may receive power from the main 24V power supply while providing voltage conversion and regulation functions needed for proper laser diode operation. The coordination between the timer, switch mode power supply, current driver, and laser diode may enable controlled generation of optical pulses with appropriate timing, duration, and energy levels for range finding applications.

The receiver may incorporate photodetector elements that may include either PIN photodiode or avalanche photodiode detector configurations depending on the sensitivity and performance requirements of the specific application. PIN photodiode detectors may provide linear response characteristics and may be suitable for applications where moderate sensitivity levels are adequate for reliable signal detection. Avalanche photodiode detectors may offer enhanced sensitivity through internal gain mechanisms that may amplify weak optical signals and may be beneficial for applications requiring detection of low-level reflected signals from distant or low-reflectivity targets.

The transmitter scheme may incorporate a timer that serves as the central control element for coordinating laser pulse generation sequences and power management functions. The timer may receive transmit trigger inputs and process these signals to generate multiple output control signals that coordinate the operation of downstream transmitter components. The timer may produce a laser on signal that provides timing control for the actual laser pulse generation process, while simultaneously generating a shutdown pulse that manages power supply operations. The coordination between these output signals from the timer may enable precise control over both the timing and power delivery aspects of laser pulse generation, which may be important for maintaining consistent pulse characteristics and energy levels throughout system operation.

The switch mode voltage power supply within the transmitter scheme may receive the shutdown pulse from the timer as a control input for managing power delivery operations. The switch mode voltage power supply may be controlled by the shutdown pulse from the timer to regulate the timing and duration of high voltage output delivery to downstream components. This control mechanism may enable the switch mode voltage power supply to synchronize power delivery with the laser pulse generation timing requirements established by the timer. The switch mode voltage power supply may convert input power from the main 24V power supply into higher voltage levels that may be suitable for driving laser diodes, while the shutdown pulse control may provide precise timing control over when this high voltage power becomes available to the laser driver circuitry.

The current driver may receive high voltage input from the switch mode voltage power supply and convert this electrical energy into current pulses suitable for driving the laser diode. The current driver may incorporate a capacitor discharge mechanism that may provide controlled energy storage and rapid energy delivery capabilities for laser pulse generation. The capacitor discharge mechanism may operate by allowing a high voltage to charge a capacitor during the energy storage phase of the pulse generation cycle. Once the capacitor reaches the appropriate charge level, the current driver may switch the capacitor to the laser diode to initiate the pulse generation process. This switching action may cause the capacitor to discharge its stored energy through the laser diode, creating the current pulse that drives optical pulse generation.

The capacitor discharge mechanism within the current driver may provide several operational advantages for laser pulse generation applications. The capacitor may store electrical energy at high voltage levels during the charging phase, which may occur between laser pulses when the laser diode does not require drive current. When the laser on command from the timer activates the current driver, the switching mechanism may rapidly connect the charged capacitor to the laser diode, allowing the stored energy to discharge through the laser diode in the form of a controlled current pulse. The discharge characteristics of the capacitor may determine the pulse shape, duration, and peak current levels delivered to the laser diode, which may directly influence the optical pulse characteristics produced by the transmitter. The rapid switching capability of the capacitor discharge mechanism may enable the generation of short-duration, high-energy pulses that may be suitable for range finding applications where precise timing and adequate signal strength are needed for accurate distance measurements.

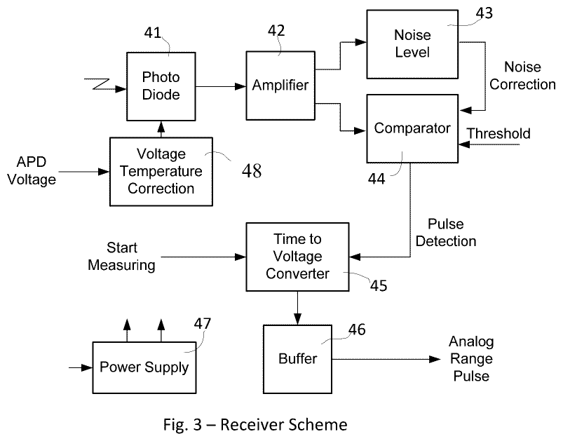

Referring to FIG. 3, the receiver scheme may incorporate a photodiode that serves as the primary optical detection element for converting incoming laser energy into electrical signals suitable for processing. The photodiode may receive optical input from reflected laser pulses returning from target objects within the detection range of the system. The photodiode may convert the received optical energy into corresponding electrical currents that may be proportional to the intensity and characteristics of the detected optical signals. The photodiode may connect to downstream signal processing components to enable further amplification and analysis of the detected signals.

The amplifier within the receiver scheme may receive electrical signals from the photodiode and provide signal conditioning functions to prepare the detected signals for subsequent processing stages. The amplifier may increase the amplitude of the electrical currents generated by the photodiode to levels that may be suitable for reliable detection and measurement operations. The amplifier may also provide impedance matching and signal conditioning functions that may enhance the signal-to-noise ratio of the detected signals. The output of the amplifier may feed into two parallel processing paths that may enable both signal detection and noise compensation functions within the receiver system.

The receiver scheme may incorporate a noise level detector that may monitor the background noise characteristics present in the amplified signals from the photodiode and amplifier The noise level detector may analyze the amplifier output to determine the ambient noise levels that may be present due to environmental conditions, electronic interference, or other sources of signal contamination. The noise level detector may generate a noise correction output signal that may be proportional to the detected noise levels within the system. This noise correction signal may provide automatic compensation for varying environmental conditions that may affect the detection performance of the receiver, including sun reflection from road surfaces and other sources of optical background interference.

The comparator may receive input signals from both the amplifier and the noise level detector to enable adaptive threshold detection with automatic noise compensation capabilities. The comparator may incorporate a threshold input that may be automatically adjusted based on the noise correction signal from the noise level detector. The total threshold of the comparator may be adjusted automatically to account for the current noise level conditions detected within the system. When the input signal from the amplifier crosses the dynamically adjusted total threshold, the comparator may generate a detection pulse output that indicates the presence of a valid reflected laser pulse. This adaptive threshold mechanism may enable the system to maintain consistent detection performance across varying environmental conditions while reducing false detections caused by background noise sources.

As further shown in FIG. 3, the receiver scheme may include a voltage temperature correction 48 that may provide compensation for temperature-related variations in the photodiode performance characteristics. The voltage temperature correction may receive APD voltage input signals and may connect to the photodiode 41 to provide bias voltage adjustments that may compensate for temperature-induced changes in photodiode sensitivity or response characteristics. Temperature variations may affect the performance of photodiode detectors, and the voltage temperature correction may provide automatic compensation to maintain consistent detection performance across different operating temperature ranges.

The time to voltage converter 45 may receive the detection pulse output from the comparator 44 along with a start measuring signal to enable precise time-of-flight measurements for range calculation purposes. The time to voltage converter may begin measuring the time delay when the start measuring signal becomes active and may terminate the measurement process when the detection pulse from the comparator indicates the detection of a reflected laser pulse. The time to voltage converter may generate an output voltage that may be proportional to the measured time delay between the start measuring signal and the detection pulse. This time delay may correspond to the time-of-flight of the laser pulse traveling from the transmitter to the target object and back to the receiver, which may enable calculation of the distance to the detected target.

The time to voltage converter may be configured with a maximum time setting that may correspond to a maximal range of thirty meters (or another maximal range value) for the range measurement system. This maximum time setting may define the longest time delay that the time to voltage converter may measure before automatically resetting or indicating an out-of-range condition. The thirty meter maximal range setting may be appropriate for traffic monitoring applications where the sensor may be mounted at typical bridge heights above roadway surfaces. The maximum time limitation may also prevent the system from responding to spurious reflections or signals that may originate from objects beyond the intended detection range of the traffic monitoring system.

The buffer 46 within the receiver scheme may receive the voltage output from the time to voltage converter and provide signal conditioning and isolation functions for the analog range pulse output. The buffer may generate an analog range pulse output signal where the amplitude may be proportional to the measured range to the detected target object. The buffer may provide impedance matching and signal drive capabilities that may enable the analog range pulse to be transmitted to external processing components or analog-to-digital conversion circuits. The analog range pulse output from the buffer may contain the range information in analog voltage form, which may subsequently be converted to digital format for further processing and analysis by the timing and processing unit shown in FIG. 1.

With continued reference to FIG. 3, the power supply unit may provide electrical power distribution to the various components within the receiver scheme to enable proper operation of the photodiode, amplifier 42, noise level detector (denoted noise level) 43, comparator 44, voltage temperature correction 48, time to voltage converter 45, and buffer 46. The power supply unit 47 may receive input power from the main system power source and may provide appropriate voltage levels and current capacity for each component within the receiver assembly. The power distribution may be designed to minimize electrical noise and interference that might otherwise affect the sensitive signal processing operations performed by the receiver components.

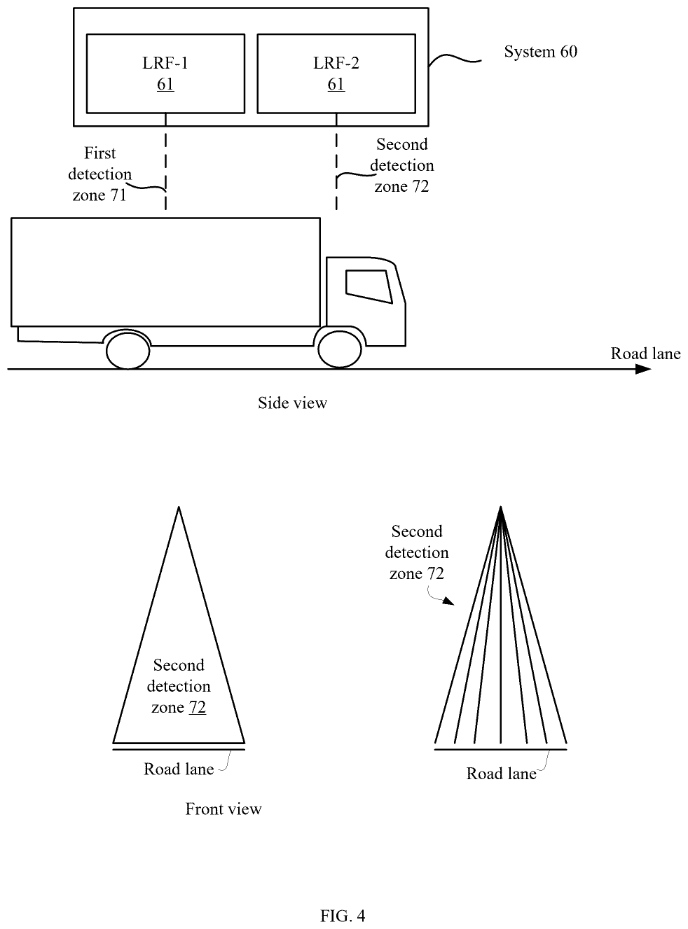

As shown in FIG. 4, the ATLAS system 60 configuration may incorporate two laser range finder units designated as LRF-1 61 and LRF-2 62 that may be mounted within a common housing structure. The housing may provide mechanical support and environmental protection for both laser range finder units while maintaining precise spatial relationships between the two detection systems. An interface connector (denoted IC) 63 may be integrated into the housing to provide electrical connections for power, control signals, and data communication with external systems or networks. The dual laser range finder configuration may enable the creation of two spatially separated laser detection zones (first detection zone 71 and second detection zone 72) that may be positioned below the mounted sensor unit for traffic monitoring applications.

The two laser range finder units within the ATLAS system create first detection zone 71 and second detection zone 72 that may extend across the width of a vehicle travel lane positioned beneath the sensor installation. These laser detection zones may provide comprehensive coverage across the monitored lane area and may enable detection of vehicles passing through either one of the detection zone. The spatial separation between LRF-1 and LRF-2 may enable time-of-flight measurements between the two laser detection zones, which may be used for accurate speed calculations based on the known distance between the laser range finder units and the measured time intervals for vehicle passage between the laser detection zones. The system may also measure accurate height profiles of vehicles as the vehicles pass through the laser detection zones and may determine accurate length measurements of vehicles based on the speed calculations and the time duration of vehicle presence within the laser detection zones.

The laser range finder units within the ATLAS system may generate wide angle flat laser beams that may differ from conventional small diameter pencil beam configurations commonly used in traditional laser measurement systems. The wide angle flat laser beam configuration may provide enhanced coverage characteristics that may enable detection across the full width of vehicle travel lanes without requiring mechanical scanning mechanisms. The flat beam geometry may create a zone-like detection pattern that may extend horizontally across the monitored area while maintaining sufficient beam intensity for reliable target detection and range measurement operations. This beam shaping approach may enable comprehensive vehicle detection coverage while maintaining the solid-state design characteristics that may eliminate moving parts and associated mechanical wear concerns. Alternatively, each one of the first detection zone 71 and the second detection zone 72 is formed from an array of spaced apart laser beams that may be oriented to each other.

The pulse repetition frequency characteristics of the ATLAS system may operate within a range of 2-10 kHz, with typical operation occurring at 10 kHz for standard traffic monitoring applications. The pulse repetition frequency may determine the rate at which laser pulses are transmitted, and corresponding range measurements are performed throughout the detection process. Higher pulse repetition frequencies may enable more frequent sampling of target positions and may provide enhanced resolution for tracking moving vehicles as the vehicles pass through the laser detection zones. The 10 kHz typical operating frequency may provide a balance between measurement resolution and system power consumption while maintaining adequate sampling rates for accurate vehicle detection and characterization.

Each measurement cycle within the system may require approximately 100 microseconds when operating at the 10 kHz pulse repetition frequency configuration. The 100 microsecond measurement cycle duration may encompass the time required for laser pulse transmission, target reflection, signal reception, and initial signal processing operations needed to generate range measurement data. This rapid measurement cycle capability may enable the system to capture multiple range measurements as vehicles pass through the laser detection zones, which may provide detailed information about vehicle dimensions, speed, and other characteristics. The short measurement cycle time may also enable tracking of high-speed vehicles without significant gaps in the measurement data that might otherwise compromise detection accuracy or vehicle characterization capabilities.

Referring to FIG. 5, the angular coverage 51 characteristics of the ATLAS system may be illustrated through the detection pattern geometry and beam angle relationships. The triangular beam pattern may demonstrate how the laser range finder units create laser detection zones that extend vertically downward from the sensor mounting position toward the roadway surface below. The beam angle configuration may determine the lateral coverage area that may be achieved at various distances from the sensor, while the detection range may establish the vertical extent of the measurement zone. A blind area may be indicated near the sensor mounting position where detection capabilities may be limited due to the geometric constraints of the optical system design.

The decision algorithm within the ATLAS system may incorporate multiple measurement validation techniques to maintain high probability of correct vehicle detection while minimizing false detection events. The algorithm may require several adjacent measurements to cross the established range threshold before confirming the presence of a vehicle within the laser detection zone. In some cases, the decision algorithm may require three consecutive measurement cycles to exceed the range threshold, which may correspond to approximately 300 microseconds of validation time at the 10 kHz pulse repetition frequency. This multi-cycle validation approach may reduce the likelihood of false detections caused by transient noise sources, environmental interference, or spurious reflections while maintaining rapid response times suitable for high-speed traffic monitoring applications.

With continued reference to FIG. 5, the velocity measurement accuracy characteristics of the system may be demonstrated through the relationship between vehicle speed and measurement error percentages. The graph may illustrate how measurement error varies as a function of vehicle velocity, with the error percentage increasing in a generally linear fashion as vehicle speeds increase from lower to higher values. The velocity measurement accuracy may achieve approximately 1.5% error for vehicles moving at 250 km/h, which may represent performance levels that may exceed the accuracy requirements for most traffic monitoring and enforcement applications. The linear relationship between velocity and error percentage may enable predictable performance characteristics across the full range of vehicle speeds typically encountered in highway traffic scenarios.

The measurement capabilities of the ATLAS system may extend beyond conventional traffic monitoring applications to include detection of objects moving at supersonic velocities. The high-frequency pulse repetition capabilities and rapid signal processing characteristics may enable the system to track and measure objects moving at speeds that may exceed typical automotive vehicle velocities by substantial margins. This extended velocity measurement capability may demonstrate the versatility of the underlying measurement technology while providing performance margins that may ensure reliable operation even under extreme traffic conditions or specialized monitoring applications where high-speed object detection may be required.

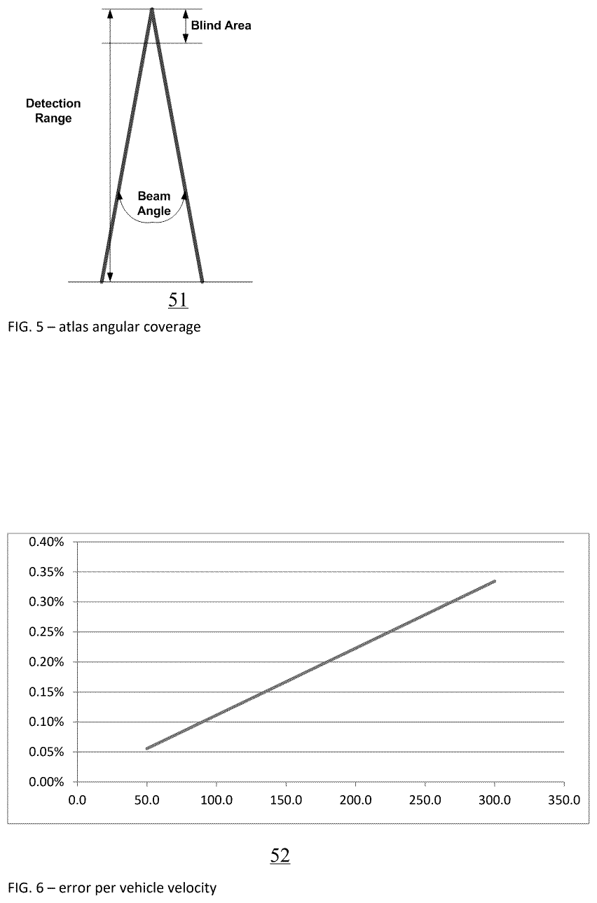

As further shown in FIG. 6, the error characteristics (see graph 52) may continue to demonstrate predictable performance relationships across extended velocity ranges, with error percentages reaching approximately 0.33% at velocities around 300 units on the measurement scale. The consistent linear relationship between velocity and measurement error may enable system calibration and compensation algorithms to account for speed-dependent measurement variations. The low error percentages across the full velocity range may indicate that the measurement system may maintain high accuracy performance even when monitoring high-speed traffic scenarios that may exceed typical highway speed limits.

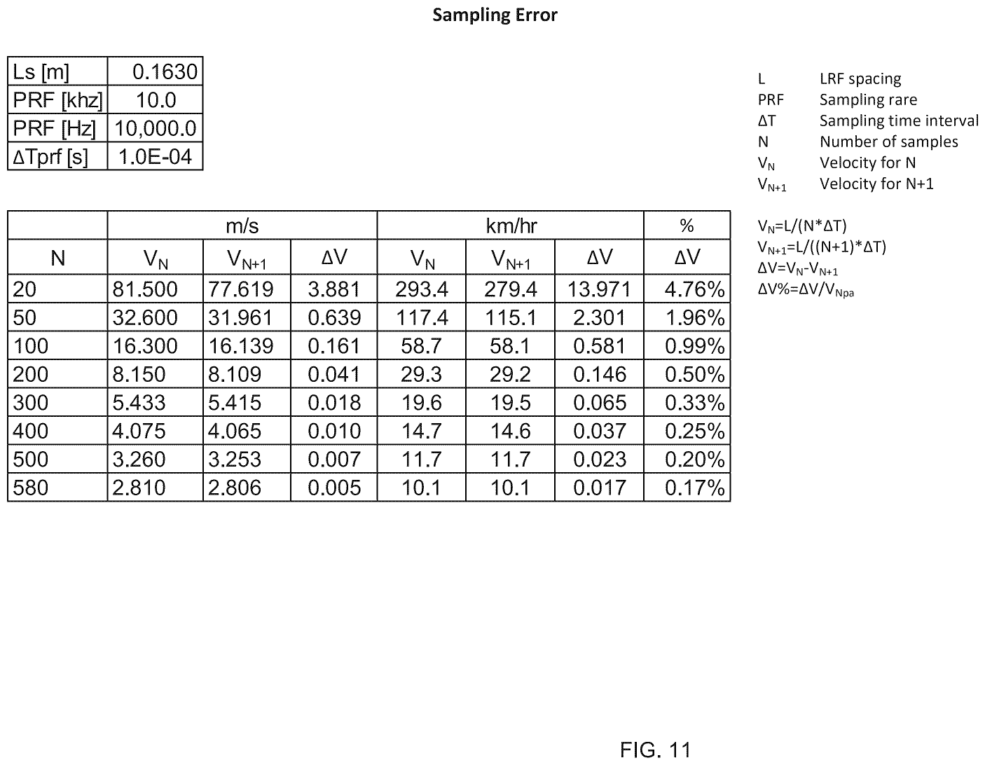

Referring to FIG. 11, the sampling error characteristics may be presented through tabular data that demonstrates the relationship between the number of measurement samples and the resulting velocity measurement accuracy. The data may show LRF spacing of 0.1630 meters and sampling rate parameters of 10 kHz with 1.0E-04 second sampling intervals, which may correspond to the 100 microsecond measurement cycle characteristics described for the system operation. The table may present velocity measurements in both meters per second and kilometers per hour units along with corresponding velocity differences and percentage differences for various sample quantities ranging from lower sample counts to higher sample counts.

The sampling data presented in FIG. 11 may demonstrate that measurement accuracy may improve as the number of samples increases, with velocity differences and percentage differences decreasing as more measurement samples are incorporated into the velocity calculations. The data may show percentage differences decreasing from approximately 4.76% at 20 samples to approximately 0.17% at 580 samples, which may illustrate how extended sampling periods may enhance measurement precision. This relationship between sample quantity and measurement accuracy may enable the system to adapt measurement parameters based on the specific accuracy requirements of different traffic monitoring applications, with longer sampling periods providing enhanced precision when measurement accuracy may be prioritized over rapid response times.

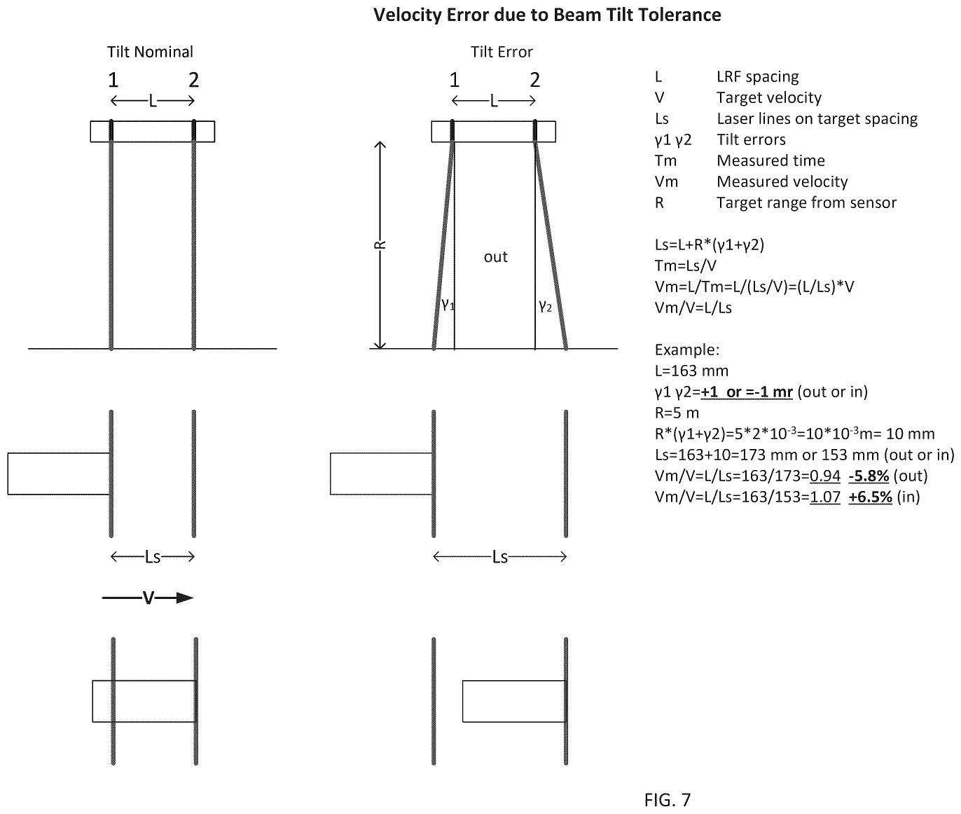

Referring to FIG. 7, the velocity measurement accuracy of the ATLAS system may be affected by beam tilt tolerance conditions that may occur during installation or operation of the sensor system. The beam tilt tolerance analysis may demonstrate how angular deviations in the laser beam positioning may influence the measured spacing between laser detection zones and subsequently affect velocity calculations. The diagram may illustrate both tilt nominal and tilt error configurations, with each configuration showing parallel laser beams separated by the nominal distance L. The tilt error section may show how angular deviations γ1 and γ2 may affect the laser beam positioning relative to a target range R, which may result in variations in the effective spacing between laser detection zones.

The mathematical relationships presented in FIG. 7 may demonstrate how beam tilt errors may propagate through the velocity measurement calculations. When angular deviations occur in the laser beam positioning, the effective laser line spacing Ls on the target surface may differ from the nominal spacing L between the laser range finder units. The velocity measurement error may be calculated based on the relationship between the measured spacing and the actual spacing, with specific examples showing how both outward and inward tilts may affect measurement accuracy. The lower portion of the diagram may show three different views of the laser beam configuration relative to a moving target with velocity V, illustrating how the laser line spacing Ls may vary depending on the beam tilt conditions.

As further shown in FIG. 7, the beam tilt tolerance may result in measurable velocity errors that may be quantified through geometric analysis of the beam positioning relative to the target surface. The angular deviations γ1 and γ2 may cause the laser beams to intersect the target surface at positions that may differ from the nominal beam positions, resulting in changes to the effective measurement baseline used for velocity calculations. The example calculations provided in the diagram may demonstrate specific error percentages for both outward and inward tilt conditions, showing how the magnitude and direction of the beam tilt may influence the resulting measurement accuracy. The geometric relationships between the beam angles, target range, and effective spacing may enable prediction of velocity measurement errors under various installation tolerance conditions.

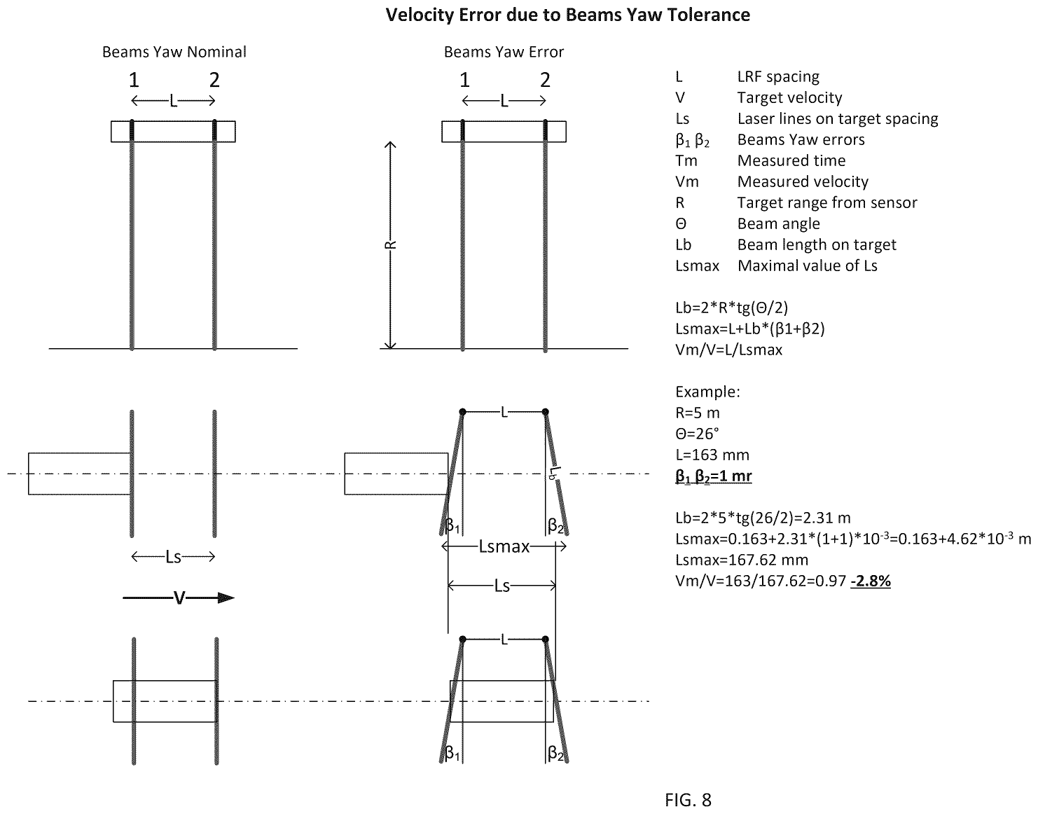

Referring to FIG. 8, the velocity error analysis may extend to beams yaw tolerance conditions that may affect the lateral positioning of the laser detection zones relative to the vehicle travel path. The diagram may show both nominal and error configurations for two parallel laser beams, with the left side illustrating the beams yaw nominal position and the right side showing the beams yaw error position. The beams may be separated by distance L and positioned at range R from the sensor, with the yaw errors β1 and β2 affecting the laser line spacing Ls on the target surface. The beam yaw tolerance analysis may include parameters such as LRF spacing, target velocity, laser lines on target spacing, beams yaw errors, measured time, measured velocity, target range from sensor, beam angle, beam length on target, and maximal value of Ls.

The mathematical equations presented in FIG. 8 may demonstrate how beam yaw errors may influence the velocity measurement calculations through changes in the effective laser line spacing on the target surface. The beam yaw errors β1 and β2 may cause the laser lines to be positioned at different lateral locations than the nominal configuration, which may result in variations in the measured time intervals between vehicle detection events at the two laser detection zones. The lower portion of the diagram may illustrate how the beam yaw errors may affect the laser line spacing Ls and may include mathematical equations for calculating beam length, maximal spacing, and velocity measurement error. An example calculation may be provided with specific values including R=5 m, θ=26°, L=163 mm, and β1,β2=1mr, resulting in a −2.8% velocity measurement error that may demonstrate the quantitative impact of beam yaw tolerance on system accuracy.

With continued reference to FIG. 8, the beam length on target and the maximal value of Ls may be influenced by the beam angle θ and the yaw error angles β1 and β2. The geometric relationships between these parameters may determine how the laser detection zones intersect with vehicles passing through the monitored area, which may directly affect the timing measurements used for velocity calculations. The beam yaw tolerance analysis may provide insight into installation requirements and alignment procedures that may be needed to maintain measurement accuracy within acceptable limits. The quantitative error analysis may enable system designers and installers to establish appropriate tolerance specifications and alignment procedures for field deployment of the ATLAS system.

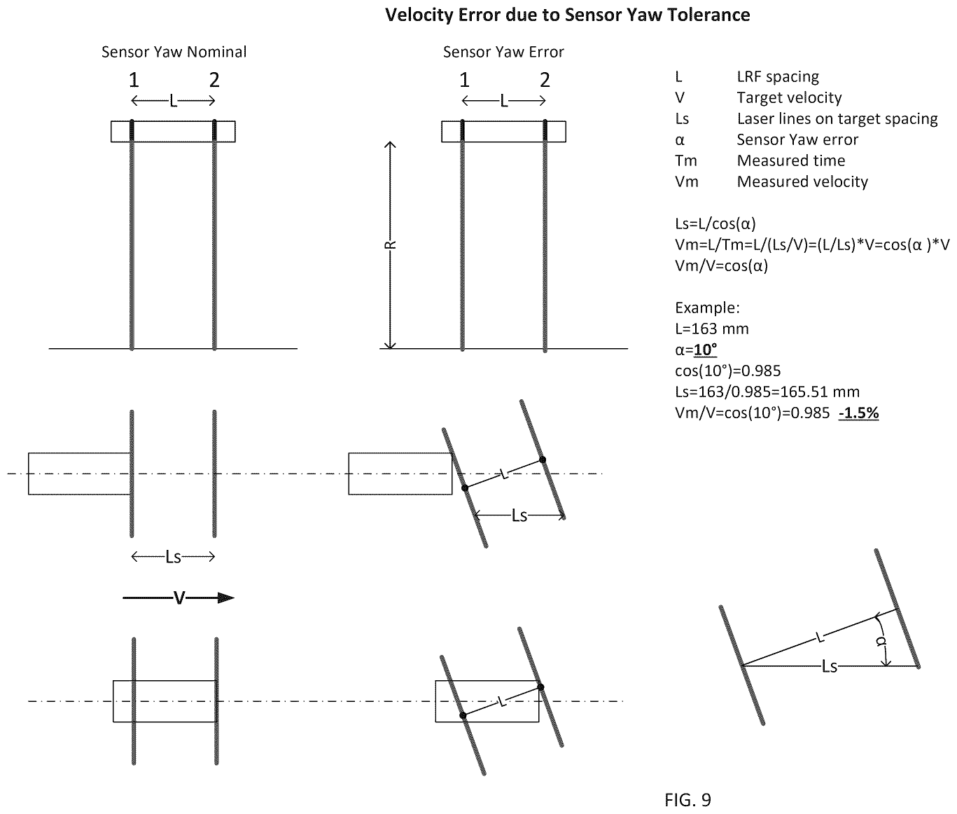

Referring to FIG. 9, the sensor yaw tolerance analysis may address how rotational positioning errors of the entire sensor assembly may affect velocity measurement accuracy. The diagram may illustrate two main configurations including a sensor yaw nominal setup and a sensor yaw error setup, each containing two parallel laser lines separated by distance L. The sensor yaw error angle α may cause the effective spacing between laser lines to differ from the nominal spacing, resulting in changes to the measured time intervals between vehicle detection events. The lower portion of the diagram may illustrate how the laser lines interact with a moving target at various angles, showing the relationship between the laser line spacing Ls and the sensor yaw error angle α.

The mathematical relationships presented in FIG. 9 may demonstrate how sensor yaw tolerance may affect velocity measurements through geometric scaling effects. The laser line spacing Ls may be related to the nominal spacing L through the relationship Ls=L/cos(α), where α represents the sensor yaw error angle. The measured velocity Vm may be related to the actual velocity V through the relationship Vm/V=cos(α), which may indicate that sensor yaw errors may result in systematic scaling errors in velocity measurements. An example calculation may be provided showing that for L=163 mm and α=10°, with cos(10°)=0.985, the resulting Ls=163/0.985=165.51 mm, yielding a velocity measurement error of −1.5%. This quantitative analysis may demonstrate how sensor yaw tolerance may contribute to overall system measurement uncertainty.

As further shown in FIG. 9, the sensor yaw tolerance effects may be distinguished from beam-level tolerance effects by considering how the entire sensor assembly orientation may influence the measurement geometry. While beam-level tolerances may affect individual laser beam positioning, sensor yaw tolerance may affect the overall orientation of both laser detection zones simultaneously. The cos(α) relationship may indicate that small yaw angles may have relatively minor effects on measurement accuracy, while larger yaw angles may result in more substantial velocity measurement errors. The geometric analysis may provide guidance for sensor installation procedures and may establish acceptable tolerance limits for sensor mounting and alignment operations.

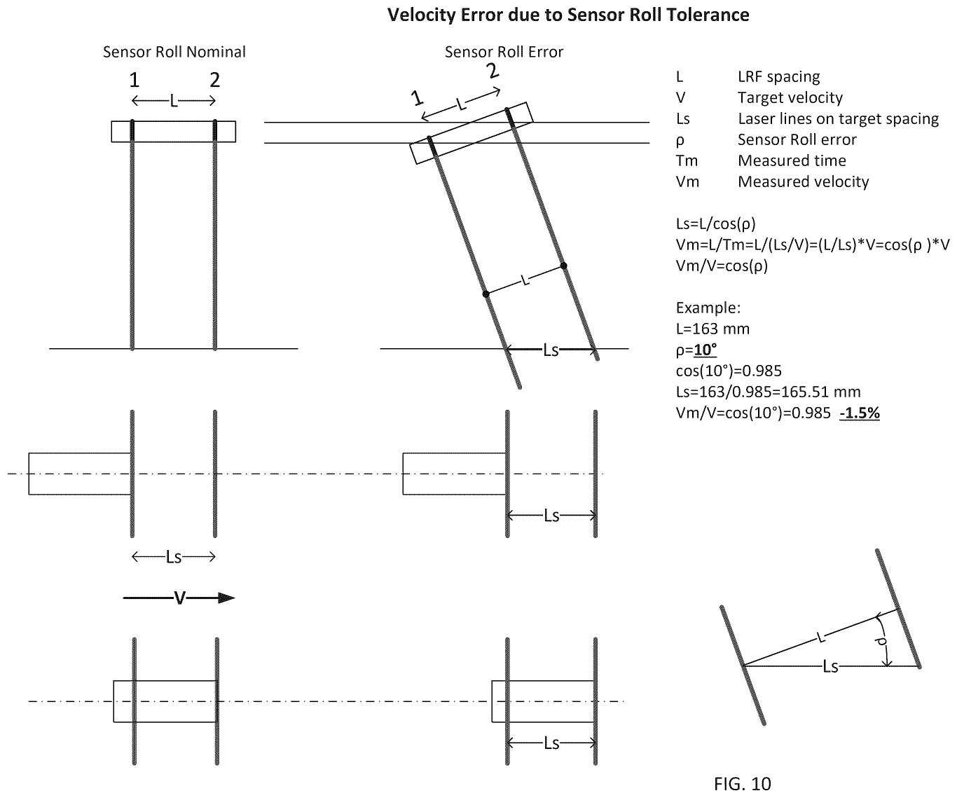

Referring to FIG. 10, the sensor roll tolerance analysis may address how rotational errors about the sensor's longitudinal axis may affect velocity measurement accuracy. The diagram may show two configurations including a sensor roll nominal position and a sensor roll error position, with the nominal position showing two parallel laser lines spaced at distance L. The sensor roll error position may demonstrate how sensor roll may affect the measured spacing Ls between laser lines, with the roll error angle ρ influencing the effective geometry of the laser detection zones. The mathematical equations may relate the measured velocity Vm to the actual target velocity V while accounting for the sensor roll error angle ρ.

The sensor roll tolerance effects may be mathematically similar to sensor yaw tolerance effects, with both types of rotational errors resulting in geometric scaling of the effective laser line spacing. As shown in FIG. 10, the relationship between the measured spacing Ls and the nominal spacing L may follow the same cos(ρ) relationship that was observed for sensor yaw tolerance, where ρ represents the sensor roll error angle. An example calculation may be provided showing that for L=163 mm and ρ=10°, where cos(10°)=0.985, the laser lines spacing Ls=163/0.985=165.51 mm, resulting in a velocity measurement error of −1.5%. This mathematical similarity between sensor yaw and sensor roll tolerance effects may indicate that both types of rotational errors may contribute to measurement uncertainty through comparable geometric mechanisms.

With continued reference to FIG. 10, the sensor roll tolerance analysis may provide insight into the mechanical mounting requirements and installation procedures that may be needed to maintain measurement accuracy within acceptable limits. The cos(ρ) relationship may indicate that sensor roll errors may have similar effects on measurement accuracy as sensor yaw errors, with small roll angles having relatively minor impacts and larger roll angles resulting in more substantial measurement errors. The quantitative error analysis may enable system designers to establish appropriate mechanical tolerance specifications for sensor mounting hardware and installation procedures. The combined effects of sensor yaw and sensor roll tolerance may contribute to the overall measurement uncertainty budget for the ATLAS system, and the mathematical relationships presented may enable prediction of system performance under various installation conditions.

The dual laser range finder configuration within the ATLAS system may enable comprehensive traffic monitoring through coordinated operation of spatially separated laser detection zones that may provide multiple measurement capabilities simultaneously. The two laser range finder units may create parallel laser detection zones that may be positioned across vehicle travel lanes with precise spacing maintained between the laser detection zones. The known distance between the laser range finder units may serve as a reference baseline for velocity calculations, while the sequential detection of vehicles passing through both zones may enable timing measurements that form the foundation for speed determination algorithms. The coordinated operation of both laser range finder units may also enable simultaneous collection of vehicle height profile data and dimensional measurements that may support vehicle classification functions.

The vehicle counting function may be implemented through detection algorithms that may monitor the sequential passage of vehicles through both laser detection zones. The system may register a vehicle count event when detection algorithms identify the characteristic signature of a vehicle entering the first laser detection zone, traversing the space between zones, and subsequently entering the second laser detection zone. The counting algorithms may incorporate validation logic that may confirm vehicle presence through analysis of range measurement changes that may exceed predetermined threshold values in both laser detection zones. The counting function may also incorporate filtering algorithms that may distinguish between valid vehicle detection events and spurious signals that might otherwise result in false counting due to environmental factors or system noise.

Velocity measurement algorithms may utilize time-of-flight analysis between the two laser detection zones to calculate vehicle speeds with high accuracy across a wide range of traffic conditions. The system may detect the moment T1 when a vehicle first intersects the laser detection zone of the first laser range finder unit, followed by detection of moment T2 when the same vehicle intersects the laser detection zone of the second laser range finder unit. The velocity calculation may be performed using the known distance L between the two laser range finder units and the measured time interval between T1 and T2, enabling determination of vehicle speed through basic distance-over-time relationships. The timing algorithms may incorporate high-resolution time measurement capabilities that may enable accurate velocity calculations even for high-speed vehicles passing through the laser detection zones.

The timing algorithms may incorporate sophisticated signal processing techniques that may enhance the accuracy and reliability of vehicle detection and timing measurements. The algorithms may analyze range measurement data from both laser range finder units to identify the precise moments when vehicles enter and exit the laser detection zones, accounting for variations in vehicle geometry and approach angles that might otherwise affect timing accuracy. The signal processing may include digital filtering techniques that may reduce the influence of measurement noise and environmental interference on timing calculations. The algorithms may also incorporate adaptive threshold mechanisms that may automatically adjust detection sensitivity based on ambient conditions and background signal levels to maintain consistent performance across varying environmental conditions.

Vehicle classification functions may be enabled through analysis of height profile data collected as vehicles pass through the laser detection zones. The system may continuously (or non-continuously) measure the height of vehicle cross-sections as vehicles traverse the laser detection zones, building comprehensive height profiles that may characterize the dimensional properties of detected vehicles. The height profile data may be combined with vehicle length measurements derived from velocity calculations and detection duration analysis to create multi-dimensional vehicle signatures. The classification algorithms may compare measured vehicle signatures against predetermined classification criteria to categorize vehicles into appropriate classes such as passenger cars, trucks, buses, or other vehicle types based on dimensional characteristics.

The vehicle length determination process may combine velocity measurements with temporal analysis of vehicle presence within the laser detection zones to calculate accurate dimensional data for classification purposes. The system may detect moment T3 when the trailing edge of a vehicle exits the second laser detection zone, enabling calculation of the total time duration during which the vehicle occupied the detection area. The vehicle length may be calculated by multiplying the measured vehicle velocity by the time interval between T1 and T3, accounting for the known spacing between laser detection zones. This length calculation method may provide accurate dimensional measurements that may be independent of vehicle speed, enabling reliable classification performance across the full range of traffic velocities encountered in highway monitoring applications.

Data processing methods within the system may incorporate multi-cycle validation algorithms that may enhance detection reliability by requiring multiple consecutive measurements to confirm vehicle presence before triggering detection events. The validation algorithms may analyze sequences of range measurements to identify consistent patterns that may indicate the presence of vehicles rather than transient noise or interference signals. The multi-cycle approach may reduce false detection rates while maintaining rapid response times suitable for high-speed traffic monitoring. The data processing may also incorporate statistical analysis techniques that may evaluate measurement consistency across multiple detection cycles to enhance the reliability of velocity and dimensional calculations.

The integration of counting, velocity measurement, and classification functions may be coordinated through central processing algorithms that may manage data flow and timing relationships between the various measurement processes. The central processing may coordinate the operation of both laser range finder units to ensure synchronized data collection and may manage the timing relationships between different measurement phases. The integrated approach may enable simultaneous execution of all three traffic monitoring functions without compromising the accuracy or reliability of individual measurements. The system may generate comprehensive traffic data records that may include vehicle counts, individual vehicle speeds, and classification information for each detected vehicle, providing complete traffic characterization data for highway monitoring and management applications.

Advanced signal processing techniques within the system may address environmental challenges that may affect traffic monitoring performance, including compensation for varying lighting conditions, weather effects, and road surface characteristics. The processing algorithms may incorporate automatic gain control mechanisms that may adjust signal amplification levels based on ambient conditions and target reflectivity characteristics. The system may also implement background subtraction techniques that may distinguish between static road surface features and moving vehicle targets to enhance detection accuracy. These environmental compensation methods may enable consistent traffic monitoring performance across diverse operating conditions including varying weather, lighting, and road surface conditions that may be encountered in highway monitoring applications.

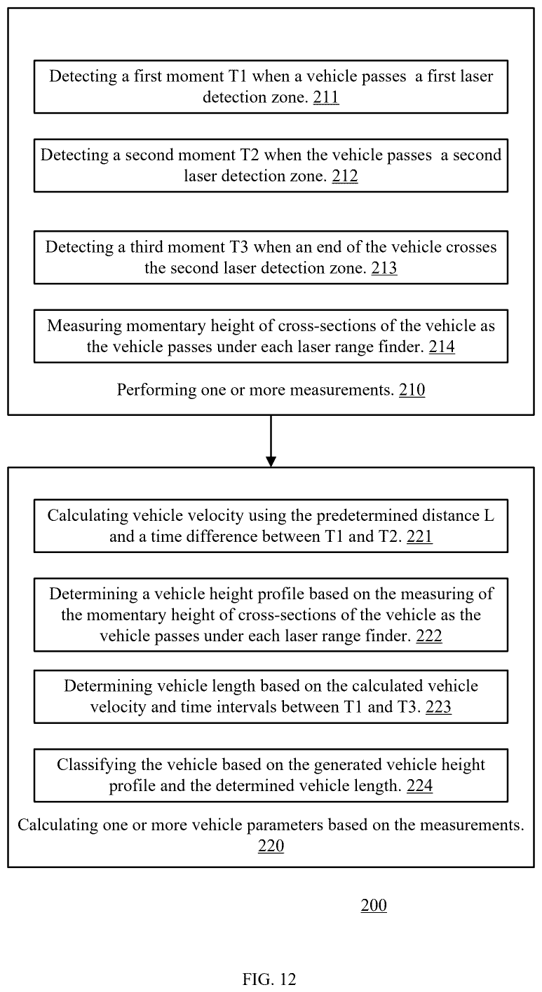

FIG. 12 illustrates an example of method 200 for monitoring traffic using a solid-state LIDAR sensor system.

Method 200 includes step 210 of performing one or more measurements.

Step 220 is followed by step 220 of calculating one or more vehicle parameters based on the measurements.

It should be noted that there may be various timing relationships between the measurements and the calculating. For example the vehicle speed may be calculated before determining a height profile of the vehicle, before completing all measurements regarding the vehicle of after completing all measurements regarding the vehicle.

Step 210 may include
a. Step 211 of detecting a first moment T1 when a vehicle passes a first laser detection zone created by a first laser range finder.
b. Step 212 of detecting a second moment T2 when the vehicle passes a second laser detection zone created by a second laser range finder spaced apart from the first laser range finder by a predetermined distance L.
c. Step 213 of detecting a third moment T3 when an end of the vehicle crosses the second laser detection zone.
d. Step 214 of measuring momentary height of cross-sections of the vehicle as the vehicle passes under each laser range finder.

Step 220 may include
a. Step 221 of calculating vehicle velocity using the predetermined distance L and a time difference between T1 and T2.
b. Step 222 of determining a vehicle height profile based on the measuring of the momentary height of cross-sections of the vehicle as the vehicle passes under each laser range finder.
c. Step 223 of determining vehicle length based on the calculated vehicle velocity and time intervals between T1 and T3; and
d. Step 224 of classifying the vehicle based on the generated vehicle height profile and the determined vehicle length.

According to an embodiment, the detecting steps are performed using laser range finders operating at a pulse repetition frequency of 2-10 kHz with each measurement cycle taking approximately 100 microseconds.

According to an embodiment, step 220 required multiple consecutive measurements to cross a predetermined range threshold before confirming vehicle presence, wherein at least three (or two or more than three) consecutive measurement cycles are required for vehicle detection validation.

According to an embodiment, method 200 includes step 230 of automatically adjusting detection thresholds based on environmental noise levels including solar reflections from road surfaces to minimize false pulse detection while maintaining high detection probability for reflected laser pulses from vehicles.

According to an embodiment, step 230 includes monitoring background noise characteristics and generating a noise correction signal proportional to detected noise levels for dynamic threshold adjustment.

A number of implementations have been described. Nevertheless, it will be understood that various modifications may be made without departing from the spirit and scope of the disclosure. Accordingly, other implementations are within the scope of the following claims.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Rather the scope of the embodiments of the disclosure is defined by the appended claims and equivalents thereof.

Any reference to a system, method or non-transitory computer readable medium should be applied to any other of system, method or non-transitory computer readable medium.

1. A solid-state LIDAR traffic sensor system, comprising:
a housing configured for installation over a traffic lane;
two laser range finders positioned within the housing, each laser range finder comprising a solid-state laser transmitter and a solid-state receiver with no moving parts, wherein the two laser range finders are spaced apart by a predetermined distance and oriented to create two parallel laser detection zones across a width of the traffic lane; and a timing and processing unit operatively connected to both laser range finders and configured to:
measure time intervals between vehicle detection events at each laser detection zone,
calculate vehicle velocity based on the predetermined distance between the laser range finders and the measured time intervals,
count vehicles crossing both laser detection zones,
generate vehicle height profiles by measuring momentary height of vehicle cross-sections as vehicles pass under each laser range finder,
determine vehicle length based on calculated vehicle velocity and time duration of vehicle presence at the laser detection zones, and
classify vehicles based on the generated vehicle height profiles and determined vehicle length.

2. The solid-state LIDAR traffic sensor system of claim 1, wherein each laser range finder comprises a laser diode transmitter that generates a wide-angle flat laser beam covering the width of the traffic lane.

3. The solid-state LIDAR traffic sensor system of claim 2, wherein each laser range finder includes an avalanche photodiode detector or a PIN photodiode detector as the solid-state receiver.

4. The solid-state LIDAR traffic sensor system of claim 1, wherein the timing and processing unit operates at a pulse repetition frequency of 2-10 kHz.

5. The solid-state LIDAR traffic sensor system of claim 4, wherein each measurement cycle takes approximately 100 microseconds.

6. The solid-state LIDAR traffic sensor system of claim 1, wherein the timing and processing unit includes noise correction circuitry configured to adjust detection thresholds based on environmental noise levels including solar reflections from road surfaces.

7. The solid-state LIDAR traffic sensor system of claim 6, wherein the noise correction circuitry automatically adjusts a total threshold of a comparator based on detected noise levels to minimize false pulse detection while maintaining high detection probability for reflected laser pulses from vehicles.

8. The solid-state LIDAR traffic sensor system of claim 1, wherein the predetermined distance between the laser range finders is accurately measured during system assembly and the system achieves velocity measurement accuracy of 1.5% for vehicles traveling at speeds up to 250 km/h.

9. The solid-state LIDAR traffic sensor system of claim 1, wherein the housing has dimensions of approximately 25 cm and weighs approximately 1.3 kg.

10. The solid-state LIDAR traffic sensor system of claim 1, wherein each laser range finder includes a time-to-voltage converter for measuring laser pulse time of flight, the time-to-voltage converter being configured with a maximum time setting corresponding to a maximal range of 30 meters.

11. A method for monitoring traffic using a solid-state LIDAR sensor system, comprising:
detecting a first moment T1 when a vehicle passes a first laser detection zone created by a first laser range finder;
detecting a second moment T2 when the vehicle passes a second laser detection zone created by a second laser range finder spaced apart from the first laser range finder by a predetermined distance L;
calculating vehicle velocity using the predetermined distance L and a time difference between T1 and T2;
measuring momentary height of cross-sections of the vehicle as the vehicle passes under each laser range finder to generate a vehicle height profile;
detecting a third moment T3 when an end of the vehicle crosses the second laser detection zone;
determining vehicle length based on the calculated vehicle velocity and time intervals between T1 and T3; and
classifying the vehicle based on the generated vehicle height profile and the determined vehicle length.

12. The method of claim 11, wherein the detecting steps are performed using laser range finders operating at a pulse repetition frequency of 2-10 kHz with each measurement cycle taking approximately 100 microseconds.

13. The method of claim 12, further comprising a step of requiring multiple consecutive measurements to cross a predetermined range threshold before confirming vehicle presence, wherein at least 3 consecutive measurement cycles are required for vehicle detection validation.

14. The method of claim 11, further comprising a step of automatically adjusting detection thresholds based on environmental noise levels including solar reflections from road surfaces to minimize false pulse detection while maintaining high detection probability for reflected laser pulses from vehicles.

15. The method of claim 14, wherein the step of automatically adjusting detection thresholds includes monitoring background noise characteristics and generating a noise correction signal proportional to detected noise levels for dynamic threshold adjustment.

16. A laser range finder for traffic monitoring applications, comprising:
a solid-state laser diode transmitter configured to generate a wide-angle flat laser beam covering a width of a traffic lane;
a photodiode detector configured to receive reflected laser pulses from vehicles; a timing circuit configured to generate transmit trigger pulses and receive trigger pulses;
a noise level detector configured to monitor background noise levels and generate a noise correction signal;
a comparator configured to receive amplified signals from the photodiode detector and automatically adjust a detection threshold based on the noise correction signal; and
a time-to-voltage converter configured to measure time-of-flight of laser pulses and generate analog range pulse outputs proportional to measured distances to detected vehicles.

17. The laser range finder of claim 16, wherein the photodiode detector comprises an avalanche photodiode detector or a PIN photodiode detector.

18. The laser range finder of claim 17, further comprising a voltage temperature correction component configured to provide bias voltage adjustments to the photodiode detector to compensate for temperature-induced changes in photodiode sensitivity.

19. The laser range finder of claim 16, wherein the time-to-voltage converter is configured with a maximum time setting corresponding to a maximal range of 30 meters.

20. The laser range finder of claim 19, further comprising a buffer configured to receive voltage output from the time-to-voltage converter and generate the analog range pulse outputs with amplitude proportional to measured distances to detected vehicles.
